(19) United States
(12) Patent Application Publication
(10) Pub. No.: US 2009/0135363 A1
(43) Pub. Date: May 28, 2009

(54) Connection arrangement for an automotive display

(76) Inventors: Chin-Fa Yeh, PingJen City (TW); Jen-Chun Peng, PingJen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,144

(22) Filed: Nov. 28, 2007

(51) Int. Cl. G02F 1/1345; G09G 3/36

(52) U.S. Cl. 349/149; 349/152; 439/78

(57) ABSTRACT

A connection arrangement for an automotive display includes a male connector disposed within a positioning base of the seat back and a female connector embedded into the rear side of the display. The male connector is positioned at the bottom of the slot of the positioning base and consists of a plurality of male terminals horizontally arranged and electrically coupled to an automotive audio/video player. The female connector includes an upper row of insertion holes and a lower row of insertion holes for a practical connection to the male connector in an obverse direction and a reverse direction, respectively. The front and rear sides of the face end of a control circuit board includes first signal contacts and second signal contacts opposing to the rear end of the female terminals of the insertion holes of the upper and lower rows. The signal contacts are adapted to be a detection module to detect if the female connector is in an obverse direction and a reverse direction, thereby determining if the display is in an obverse direction and a reverse direction. Thus, an automatic turning process can be carried out for the adjustment of the image output. In this way, the display can be inserted into the seat back in an obverse direction and a reverse direction to provide the rear-seat passengers with different desired viewing angles.

### BACKGROUND OF THE INVENTION

1. Field of the Invention

The invention relates to a connection arrangement for an automotive display, and more particularly to a connection arrangement that permits an LCD-display to be detachably disposed on a seat back Moreover, the display can be brought in an upright position or in an upside-down position for providing the rear-seat passengers with different viewing angles.

2. Description of the Related Art

In recent years, the development of LCD-displays is toward a miniature design. The LCD-displays have been widely installed in the cars due to their low price. If the display is installed for the front-seat driver and passengers, it is normally mounted on the front panel, or embedded within the panel. The display will be pulled out of the panel when used. If the display is installed for the back-seat passengers, it is normally fixed on the middle handrail of the front seat or mounted at the bottom of the roof. The display is swiveled downward when used.

However, the driver, particularly during the driving, will be unable to obtain a complete view of the area behind the vehicle via the rearview mirror if the display is installed at the bottom end of the roof and swiveled downward for the passengers to use. Also, if the display is installed at the central handrail of the front seat, the narrow space within the car will become smaller.

In order to avoid the above-mentioned drawbacks, a headrest-mounted monitor 10 has been developed (see FIG. 1). The monitor 10 is embedded in the rear side of the headrest 11. Such structure is disclosed in TW M287769, TW M253523, TW M206303, and TW M3102679 filed by the applicant of the present invention as well as in TW M255814 filed by Action Electronic Co., Ltd. Moreover, U.S. Pat. No. 7,044,546 and U.S. Pat. No. 7,245,274 as well as U.S. Pat. No. 6,956,628 and U.S. Pat. No. 6,739,654 of the applicant of the invention also teach the similar structure of the headrest-mounted monitor. The headrest-mounted monitor does not occupy additional space. Meanwhile, the view obtained via the rearview mirror won't be affected. However, the greatest drawbacks of this headrest-mounted monitor lie in that it's impossible to adjust the height. Hence, the view is also directed upward when the rear-seat passengers are children 18 (see FIG. 2). The fact that the height of the monitor 10 is not adjustable is unchangeable although the inclination angle thereof is adjustable. To look up at the screen in such an angle for a long time will cause aches in their neck. Moreover, the headrest-mounted type design will destroy the integrity of the headrest 11. As shown in FIG. 3, the cable 12 has to pass through the inside of the supporting stems 13, and this will result in inconvenience in assembly. For the car model like Mercedes-Benz, the supporting stems 13 of the headrest are solid so that it's impossible to receive the cable 12. Therefore, the appearance must be affected due to the fact that the cable 12 is exposed.

FIG. 4 illustrates a perspective view of a conventional display 14 embedded in a seat back 15. Such a structure is disclosed in U.S. Pat. No. 5,267,775 and U.S. Pat. No. 5,507,556. As shown in FIG. 5, the display 14 in the seat back 15 may provide the children with a suitable viewing angle. However, such a height of the display 14 will cause discomfort for adults 17 since they have to lower their head to watch the display. Consequently, the conventional headrest-mounted and backrest-mounted monitors have their own advantages and disadvantages so that they require further improvements.

### SUMMARY OF THE INVENTION

It is a primary object of the invention to provide a connection arrangement for an automotive display by means of which the display can be inserted into the seat back. Meanwhile, the display can be directed upward in an upright position so as to raise the viewing angle. Moreover, the display can be turned upside down at 180° to be fixed on the seat back, thereby lowering the viewing angle. In this way, an optimal viewing angle according to different requirements of the rear-seat passengers is achieved.

It is another object of the invention to provide a connection arrangement for an automotive display through which the female connector has an upper row of insertion holes and a lower row of insertion holes such that the display employs the insertion holes of different rows to establish an electric connection with the male terminal either in an upright position or in an upside-down position. Moreover, the signal of the connecting pins is used to determine if the display in an upright position or in an upside-down position. In addition, the image can be automatically turned upside down such that the image represented by the display is always directed upward no matter which angle the image is viewed by the rear-seat passengers from. Furthermore, the passenger can normally operate and use the display. Thus, a convenient use and an ergonomic effect can be achieved.

It is a further object of the invention to provide a connection arrangement for an automotive display which ensures the integrity of the automotive seat since the display is not required to be embedded into the headrest or backrest. Thus, an easy and convenient installation is guaranteed. In addition, a simple removal is also achieved such that the operator can easily take out or store the display when getting out of the automobile. Accordingly, the practicality and safety in use is achieved.

In order to achieve the above-mentioned objects, the invention includes:

a) a positioning base mounted on an automotive seat back and having a slot with an engaging groove at both sides thereof;

b) a male connector disposed at the bottom of the slot, the male connector consisting of a plurality of male terminals arranged in a horizontal manner, the male connector being electrically connected via a first cable to an automotive audio/video player;

c) a display having at the back side thereof an insertion body insertable into the slot;

d) a female connector disposed at the front end of the insertion body and having a first row of insertion holes and a second row of insertion holes for establishing an electric connection to the male terminals in an obverse direction and a reverse direction, the insertion holes of the first and second rows internally including female terminals, the rear end of the female terminals horizontally protruding at the rear end of the insertion holes of the first and second rows;

e) a control circuit board embedded into the insertion body, the front and rear sides of the face end of the control circuit board having first signal contacts and second signal contacts opposing to the rear end of the female terminals of the insertion holes of the first and second rows such that an electric connection is ensured when the front side of the control circuit board is inserted into the female terminals of the first and second rows;

f) a second cable electrically coupled to the control circuit board, the rear end of the second cable being extended out of the insertion body and connected to the display;

g) a pair of elastic positioning pieces opposing to each other and arranged at both sides of the insertion body, the external side of the free end of the elastic positioning pieces being exposed to the left and right sides of the insertion body, each of the elastic positioning pieces having a locking member that is engaged into the engaging groove at both sides of the slot when the insertion body is inserted into the slot for establishing an electric connection;

h) a sensitive switch electrically connected to the control circuit board and having a touch control switch in connection to one of the elastic positioning pieces such that the control circuit board is switched on or off when the insertion body is inserted into or pulled out of the slot; and

i) an adjusting unit for automatically turning the image, the first and second signal contacts on the control circuit board serving as a detection module that determines if the female terminals of the first row or the female terminals of the second row is electrically coupled to the male terminals, wherein it is determined if the display is in an upright position or in an upside-down position, and wherein, when the display is in an upside-down position, an automatic image-turning process is performed.

### BRIEF DESCRIPTION OF THE FIGURES

The accomplishment of this and other objects of the invention will become apparent from the following descriptions and its accompanying figures of which:

FIG. 1 is a perspective view of a conventional headrest-mounted display;

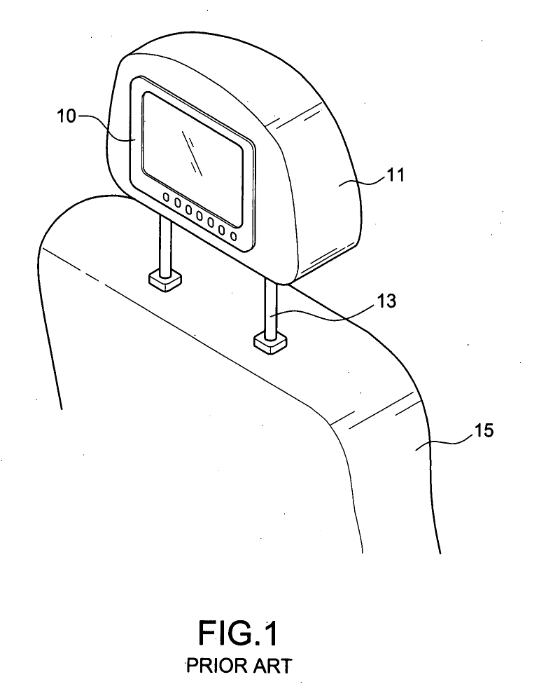

FIG. 2 is a side view of the conventional headrest-mounted display;

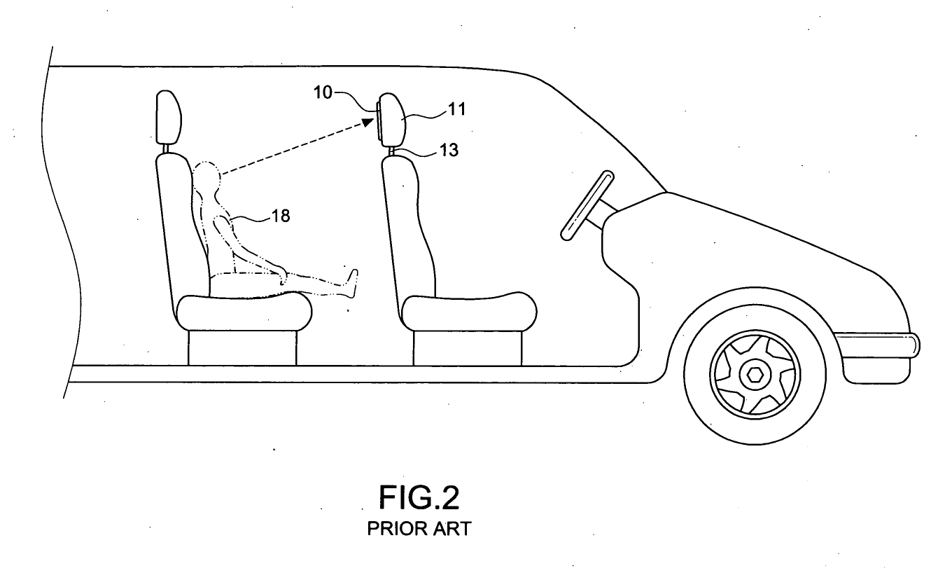

FIG. 3 is a side view of an application state of the conventional headrest-mounted display;

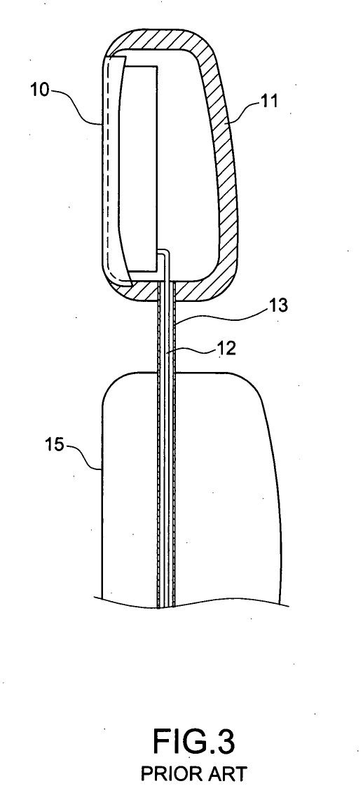

FIG. 4 is a perspective view of a conventional backrest-mounted display;

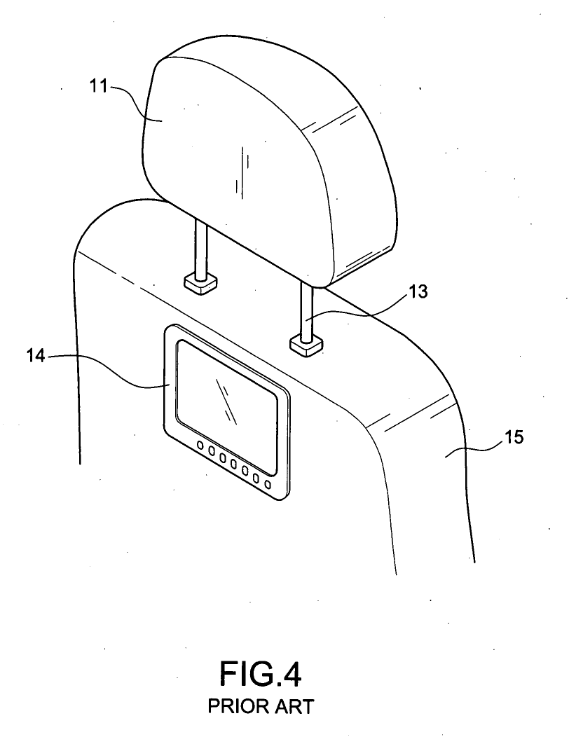

FIG. 5 is a side view of an application state of the conventional backrest-mounted display;

FIG. 6 is an exploded perspective view of the invention;

FIG. 7 is a perspective view of a male and a female connector of the invention;

FIG. 7A is a cutaway view of FIG. 7;

FIG. 8 is an exploded perspective view of an insertion body of the invention;

FIG. 9A and 9B are schematic drawings of the male and female connectors of the invention, illustrating the assembly process thereof;

FIG. 10 is a schematic drawing of a female connector and a sensitive switch of the invention;

FIG. 11 is an exploded view of a first application type of the invention;

FIG. 12 is an assembly view of the first application type of the invention;

FIG. 13 is a perspective view of the first application type of the invention;

FIG. 14 is an exploded view of a second application type of the invention;

FIG. 15 is an assembly view of the second application type of the invention;

FIG. 16 is a perspective view of the second application type of the invention;

FIG. 17 is a block diagram of an adjusting unit for automatically turning the image of the invention; and

FIG. 18 is a schematic drawing of another applicable embodiment of the male and female connectors of the invention.

### DETAILED DESCRIPTION OF THE PREFERRED EMBODIMENT

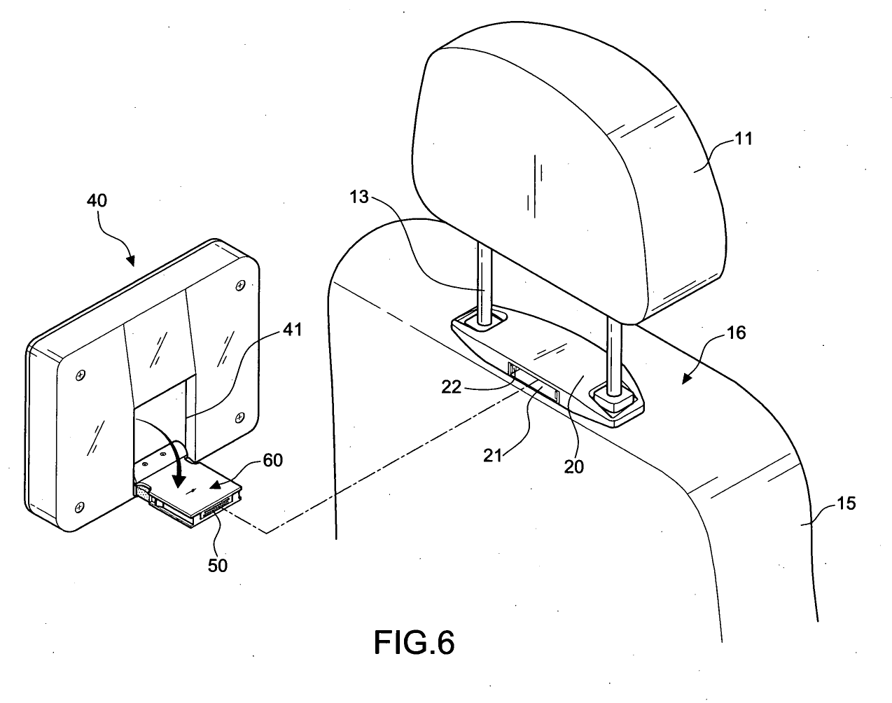

First of all, referring to FIGS. 6 through 10, a preferred embodiment of the invention includes a positioning base 20, a male connector 30, a display 40, a female connector 50, a control circuit board 70, a second cable 73, a sensitive switch 74, a pair of elastic positioning pieces 80, and an adjusting unit 90 for automatically turning the image.

The positioning base 20 is mounted on an automotive seat back 15. According to the embodiment, the positioning base 20 is disposed at the bottom end of supporting stems 13 of a headrest 11 on the top 16 of the seat back. In other words, the existing supporting stems 13 are employed to fix the positioning base 20. This is a preferred arrangement. However, the design should not be restricted thereto. The positioning base 20 includes a slot 21 with an engaging groove 22 at both sides thereof.

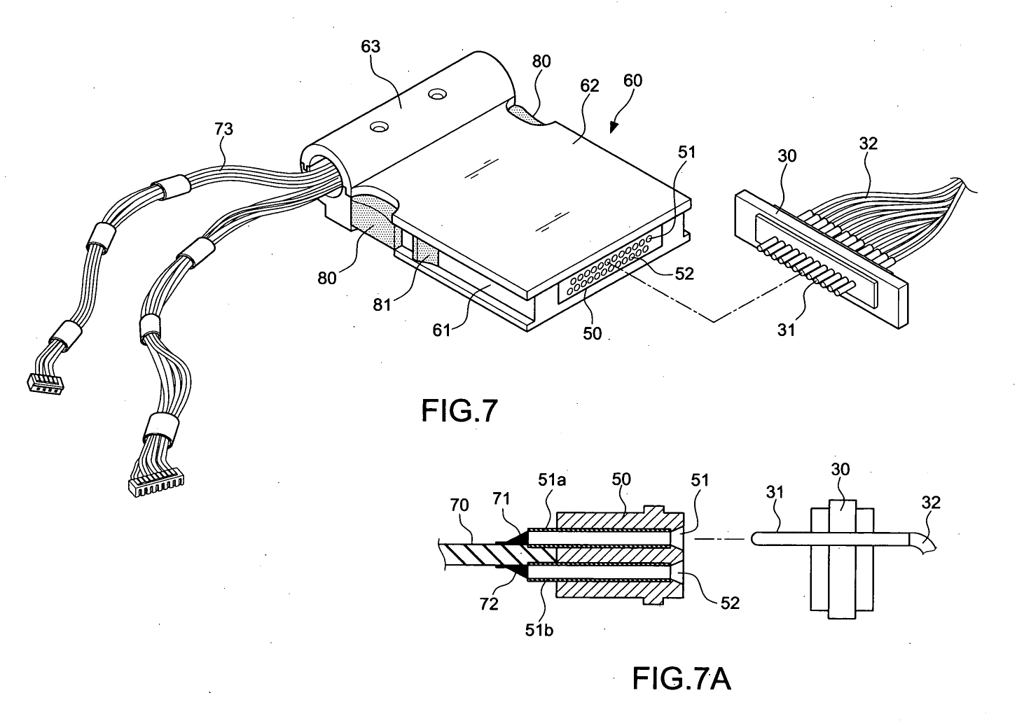

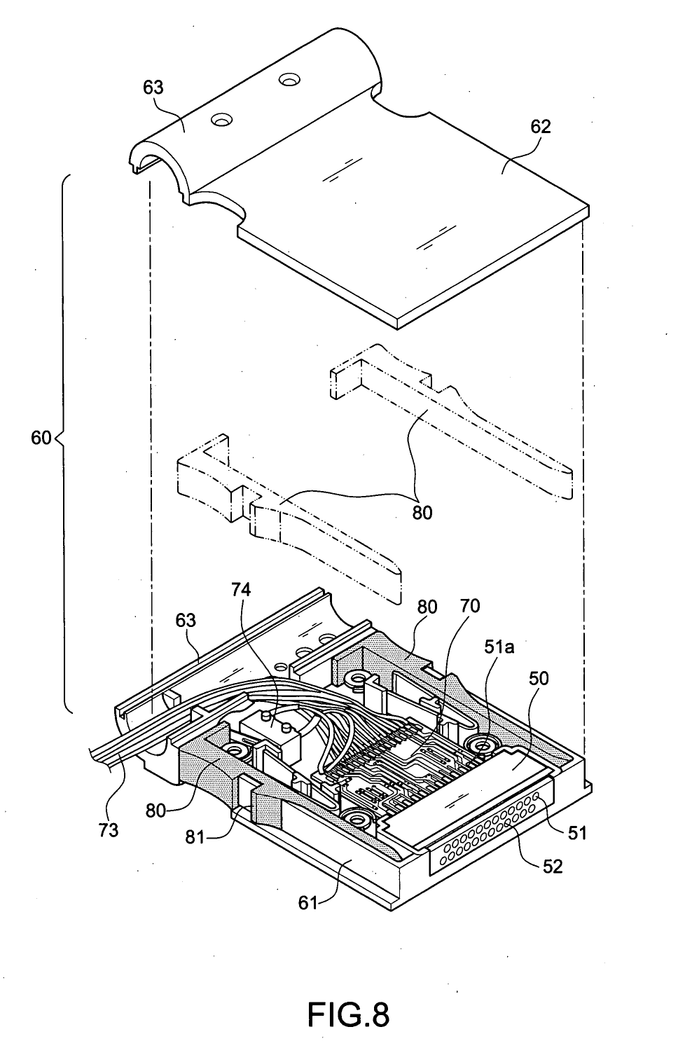

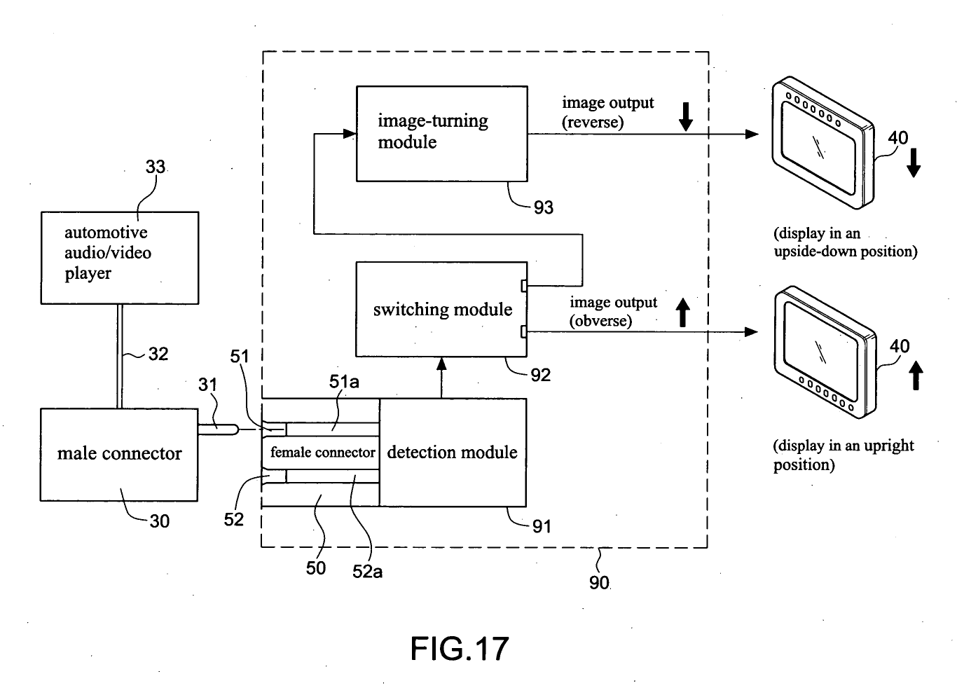

The male connector 30 is disposed at the bottom of the slot 21. As shown in FIG. 7, the male connector 30 consists of a plurality of male terminals 31 arranged in a horizontal manner. The male connector 30 is electrically connected via a first cable 32 to an automotive audio/video player 33 (see FIG. 17). The automotive audio/video player 33 is selected from a group consisting of DVD, VCD, and digital set-top box, etc. According to this embodiment, the male terminals 31 include twelve pins 31, but the design thereof should not restricted thereto. In other words, the male terminals 31 can be 24 pins or the pin can be replaced by other elements. More descriptions thereto won't be given hereinafter.

The display 40 can be an LCD-display. The back side of the display 40 includes an insertion body 60 insertable into the slot 21. In other words, the insertion body 60 is formed corresponding to the dimensions of the slot 21 for a smooth insertion and attachment as well as for establishing an electric connection. As a result, the female connector 50 is formed at the front end of the insertion body 60.

The female connector 50 includes a first row of insertion holes 51 and a second row of insertion holes 52 for establishing an electric connection to the male terminals 31 in an obverse direction and a reverse direction. The insertion holes 51, 52 of the first and second rows have twelve insertion holes in match of the twelve pins of the male terminals 31. As shown in FIG. 7A, the insertion holes 51, 52 of the first and second rows internally includes female terminals 51a, 52a. The rear end of the female terminals horizontally protrudes at the rear end of the insertion holes 51, 52 of the first and second rows. In other words, the female terminals 51a, 52a of the insertion holes 51, 52 of the first and second rows define a connection space for the insertion of the male connector 30.

The control circuit board 70 is embedded into the insertion body 60. The front and rear sides of the face end of the control circuit board 70 include first signal contacts 71 and second signal contacts 72 at the end thereof for establishing an electric connection to the female terminals 51a, 52a of the insertion holes 51, 52 of the first and second rows. For example, the female terminals 51a, 52a of the first and second rows are Pin 1˜12 and Pin 13˜24, respectively. Accordingly, there are also 12 first and 12 second signal contacts 71, 72 to ensure an electric connection of the control circuit board 70 both to the first row of the insertion holes 51 and to the second row of the insertion holes 52.

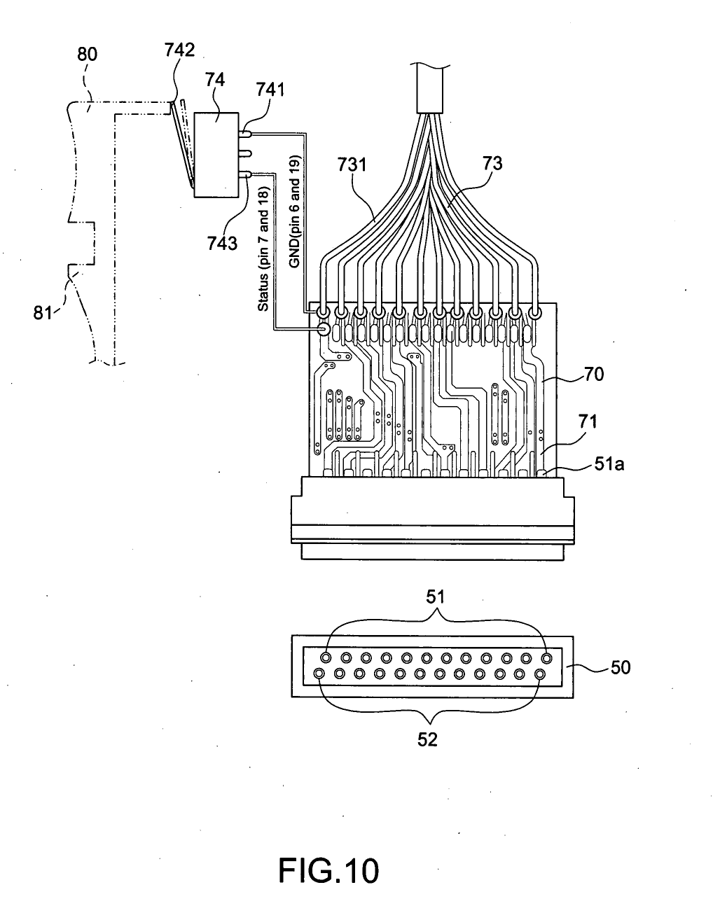

The second cable 73 is electrically coupled to the control circuit board 70. As shown in FIG. 10, the second cable 73 has 12 strands corresponding to the female connector 50 with 24 holes. Moreover, one of the strands 731 is electrically connected to the ground terminals (GND) of both first and second signal contacts 71, 72. In this embodiment, the ground terminals (GND) are Pin 6 and Pin 19. The rear end of the second cable 73 is extended out of the insertion body 60 to the inside of the display 40.

The sensitive switch 74 includes a first connecting pin 741 in connection to the ground terminals (GND) (Pin 6 and Pin 19) and a third connecting pin 743 in connection to the Pin 7 and Pin 18 of the control circuit board 70. In addition, the sensitive switch 74 further includes a touch control switch 742. The control circuit board 70 is switched on or off by touching the touch control switch 742.

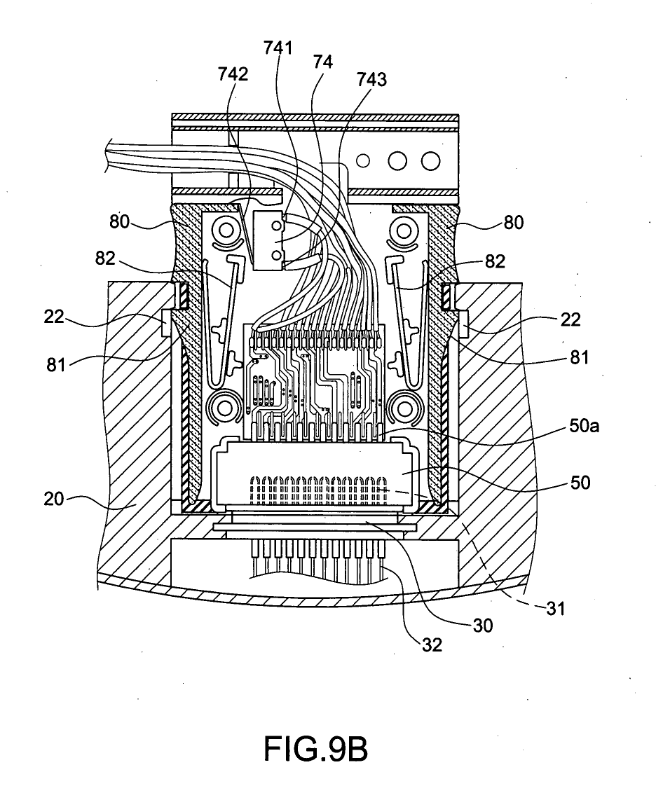

The elastic positioning pieces 80 opposing to each other are arranged at both sides of the insertion body 60. The external side of the free end of the elastic positioning pieces 80 protrudes at the left and right sides of the insertion body 60 such that a locking member 81 is formed at each of the elastic positioning pieces 80 and is engaged into the engaging groove 22 at both sides of the slot 21 when the insertion body 60 is inserted into the slot 21 for establishing an electric connection. As shown in FIGS. 9A and 9B, both sides of the free end of the elastic positioning pieces 80 are subject to the inserting force and moved inwardly when the insertion body 60 is inserted into the slot 21 of the positioning base 20. When they reach at a certain position, the elastic positioning pieces 80 will be pushed outwardly by the resilience such that the locking member 81 is locked within the engaging groove 22. In this way, the electric connection between the female connector 50 and the male connector 30 is established.

The resilience of the elastic positioning pieces 80 is created by V-shaped elastic pieces 82 disposed at the inner side thereof. However, this should not be restricted thereto. In other words, the elastic positioning pieces 80 can obtain resilience by their form and material.

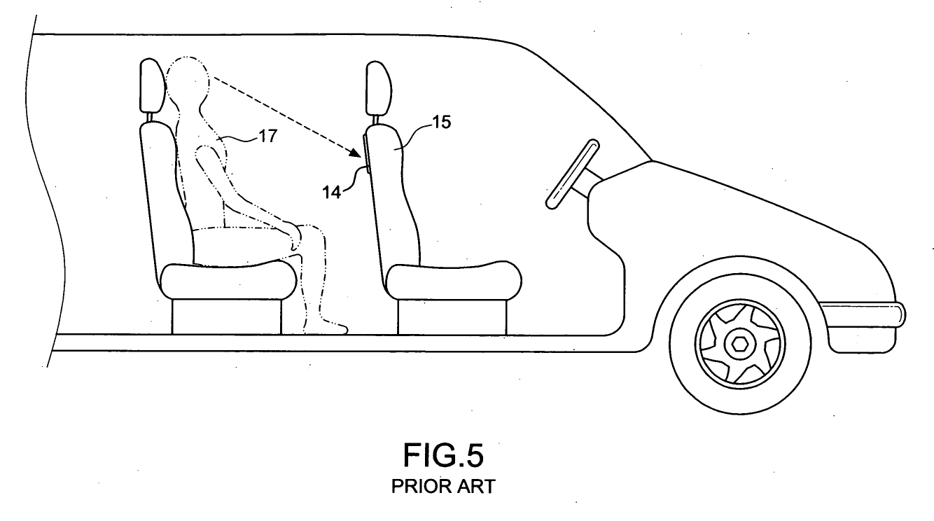

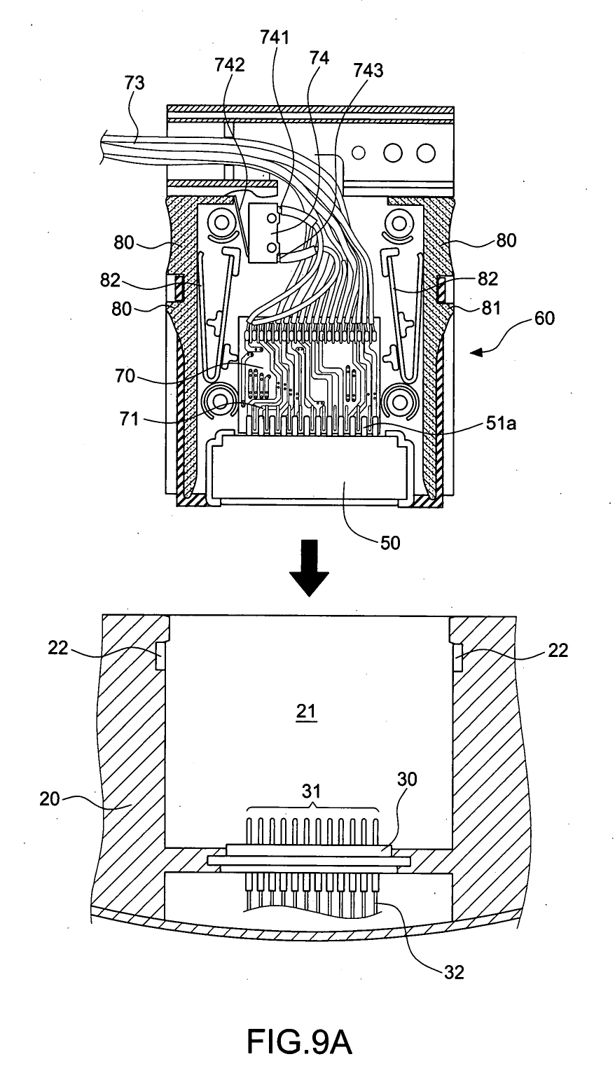

As shown in FIG. 8, the insertion body 60 consists of a base member 61 and a cover member 62. The front side of the insertion body 60 is adapted to receive the female connector 50. The rear end of the insertion body 60 is formed as a hollow pivot joint 63 in pivotal connection to the display 40. The above-mentioned second cable 73 is extended from one end of the pivot joint 63 to the inside of the display 40. According to a preferred embodiment as shown FIG. 5, the rear side of the display 40 is provided with a cavity 41 for receiving the insertion body 60 when swiveled back against the wall of the cavity 41. When the insertion body 60 is swiveled outwardly in a position perpendicular to display 40 to form an L-shape, the insertion body 60 is insertable into the slot 21.

Based upon the above-mentioned technical features, the operation and the effect of the invention are detailed as follows:

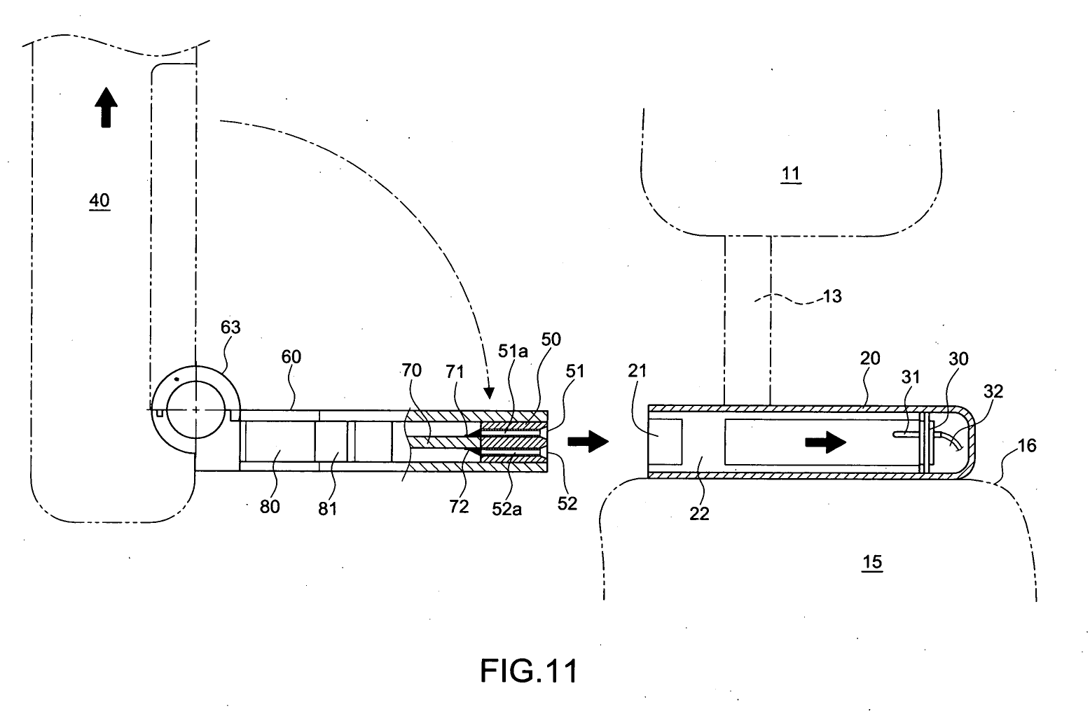

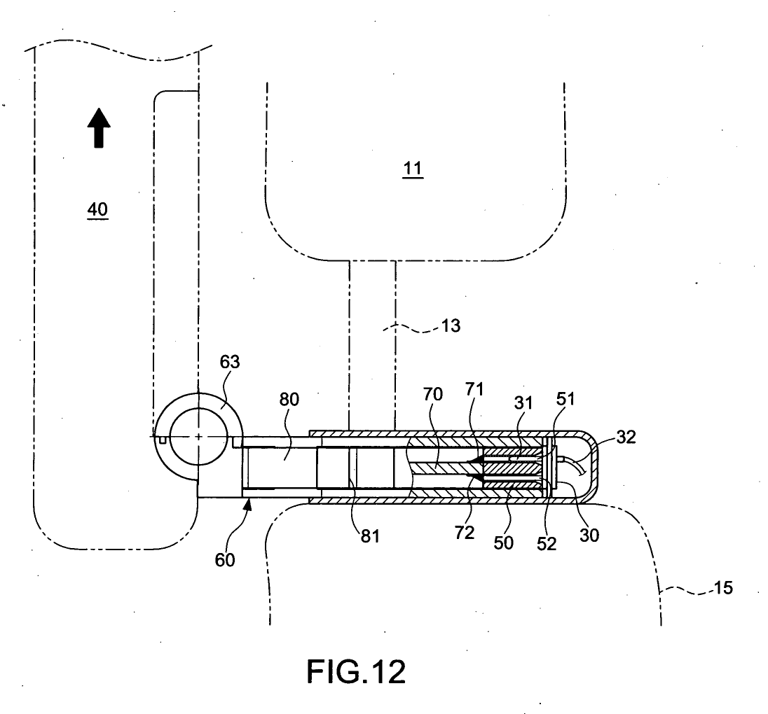

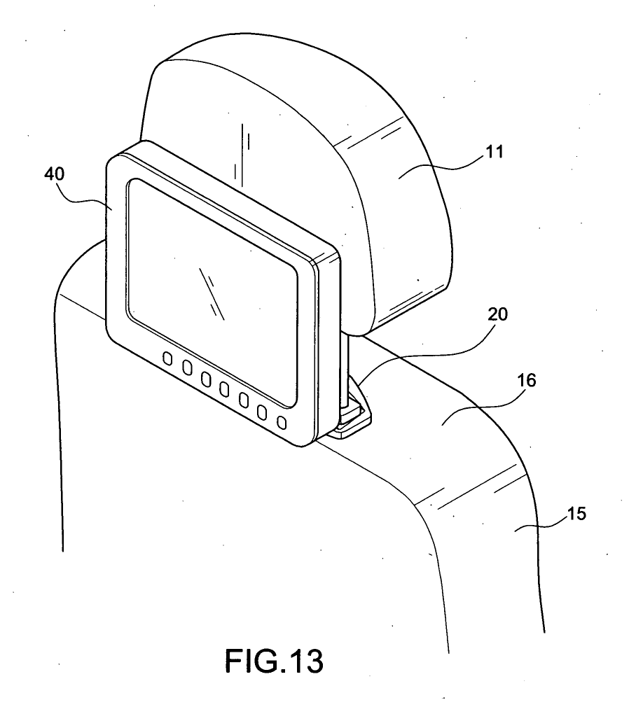

As shown in FIGS. 11 through 13, the display 40 is directed upwardly in an upright position and attached to the positioning base 20. For the operator, the positioning base 20 is fixed at the top 16 of the seat back and electrically coupled to the automotive audio/video player 33. Accordingly, the electric connection between the female connector 50 and the male connector 30 at the bottom of the slot 21 is established only when the insertion body 60 fits into the slot 21. In this way, a first application position of the display 40 is created and the display 40 is situated at a height behind the headrest 11. In fitting the insertion body 60 into the slot 21, the elastic positioning piece 80 at one side thereof will be moved inwardly to activate the sensitive switch 74. Therefore, the control circuit board 70 is brought in an ON state (see FIGS. 9A, 9B and 10). When the display 40 is pulled out, the sensitive switch 74 will be activated again to disconnect the control circuit board 70 in an OFF state.

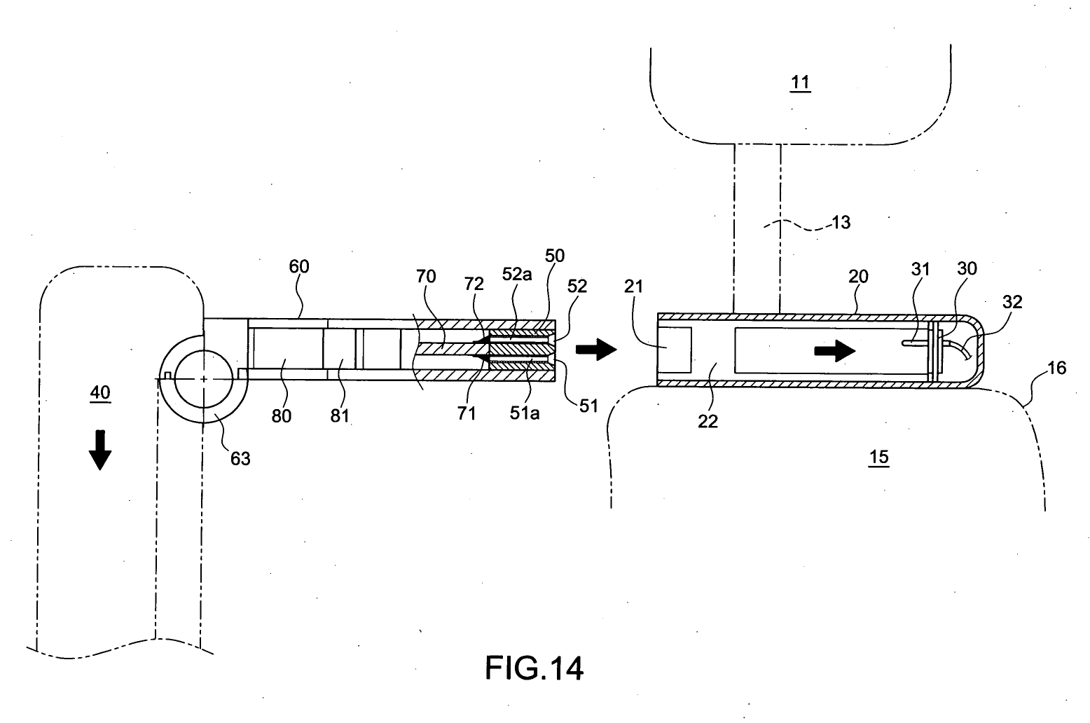

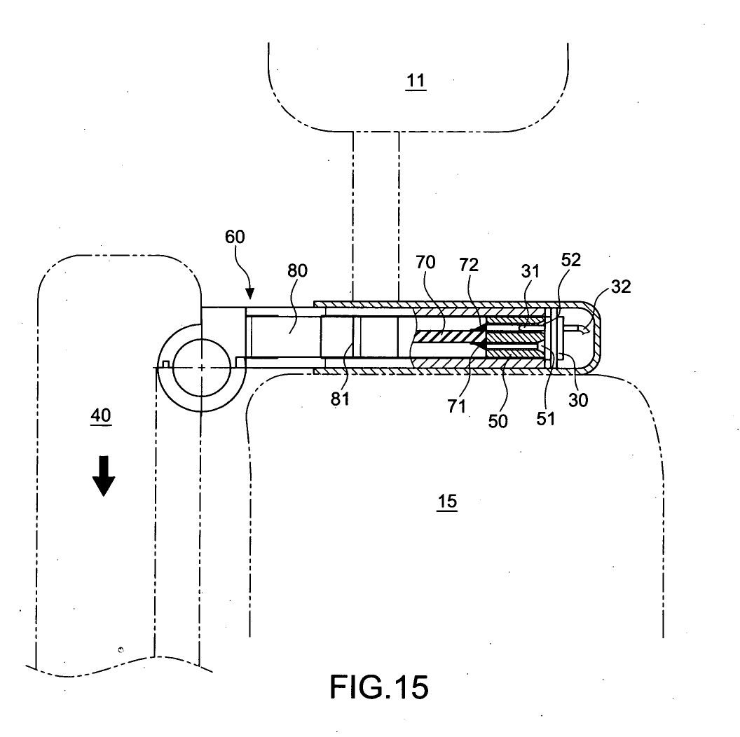

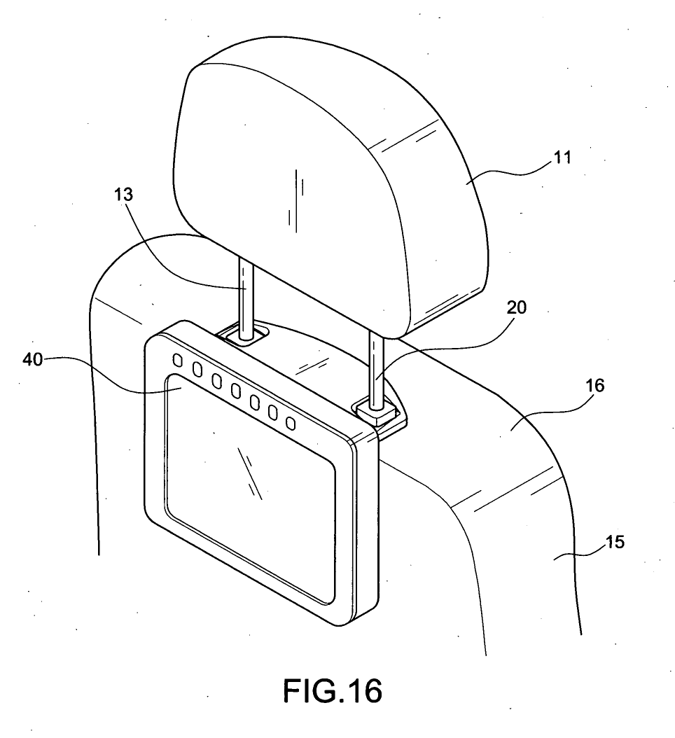

As shown in FIGS. 14 through 16, the display 40 is in an upside-down position and fixed on the positioning base 20. The operation is done with the above-mentioned way. However, the difference lies in that the display 40 is turned upside down in a position behind the rear side of the automotive seat back 15, thereby creating a second application position. As a result, the passengers at the back seat can conveniently adjust the viewing height according to their needs.

Referring to FIG. 17, the image of the display 40 can be automatically turned no matter if the display 40 is in an upright position or in an upside-down position. Additional adjustment done by the passengers is not required. In other words, the control circuit board 70 includes an adjusting unit 90 for automatically turning the image. The insertion holes 51, 52 of the first and second rows of the female connector 50 are arranged in a parallel and symmetric manner. In this way, the insertion holes 51 of the first row and the male terminals 31 can be electrically connected when the display 40 is in an upright position. When the display 40 is in an upside-down position, the insertion holes 52 of the second row and the male terminals 31 are electrically connected. In this case, the first and second signal contacts 71, 72 at the front and rear sides of the control circuit board 70 serve as a detection module 91 that determines if the female terminals 51a of the first row or the female terminals 52a of the second row is electrically coupled to the male terminals 31. Furthermore, it is determined if the display 40 is in an upright position or in an upside-down position. When the display 40 is in an upside-down position, a switching module 92 transmits a signal to an image-turning module 93 for carrying out an automatic image-turning process. In this way, a normally operating and viewing effect is always ensured when the display 40 is inserted into the positioning base 20, no matter if the display 40 is directed upwardly in an upright position or turned at 180° in an upside-down position. The image-turning module 93 belongs to the prior art such as Windows Movie Maker so that no further descriptions thereto are given hereinafter.

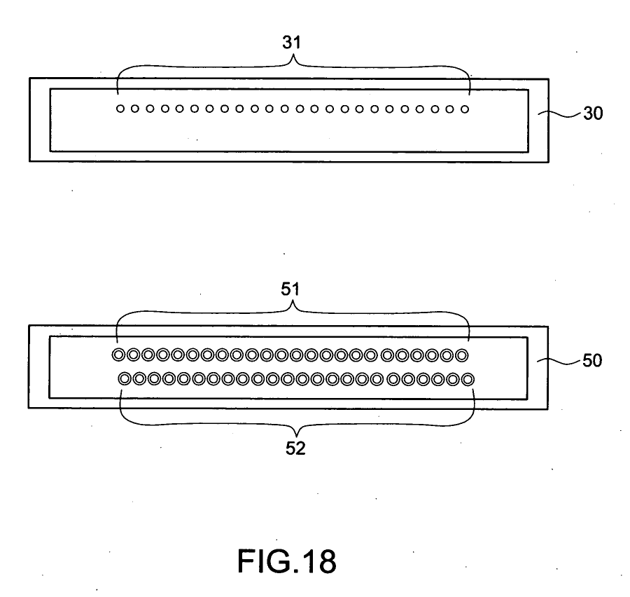

FIG. 18 illustrates another applicable embodiment of the male and female connectors 30, 50. The male terminals 31 have 24 pins while the female connector 50 correspondingly includes 24 insertion holes 51 of the first row and 24 insertion holes 52 of the second row. The technical features of this embodiment are identical to those of the above-mentioned embodiment so that no further descriptions thereto are given hereinafter.

According to the invention, the male connector 30 is disposed within the slot 21 of the positioning base 20 while the female connector 50 is embedded in the insertion body 60 at the rear side of the display 40 such that a convenient assembly on the seat back and an easy disassembly therefrom are ensured. Moreover, the output images can be turned in an upside-down position in match of the use of the display 40 by means of different signal contact of the upper and lower insertion holes, thereby permitting the back-seat passengers to adjust the display 40 to a different viewing height according to their own requirements. It's very practical. In addition, a simple and convenient human/machine operation interface is provided for an ergonomic usage.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A connection arrangement for an automotive display, comprising:
a) a positioning base mounted on an automotive seat back and having a slot with an engaging groove at both sides thereof;
b) a male connector disposed at the bottom of the slot, the male connector consisting of a plurality of male terminals arranged in a horizontal manner, the male connector being electrically connected via a first cable to an automotive audio/video player;
c) a display having at the back side thereof an insertion body insertable into the slot;
d) a female connector disposed at the front end of the insertion body and having a first row of insertion holes and a second row of insertion holes for establishing an electric connection to the male terminals in an obverse direction and a reverse direction, the insertion holes of the first and second rows internally including female terminals, the rear end of the female terminals horizontally protruding at the rear end of the insertion holes of the first and second rows;
e) a control circuit board embedded into the insertion body, the front and rear sides of the face end of the control circuit board having first signal contacts and second signal contacts opposing to the rear end of the female terminals of the insertion holes of the first and second rows such that an electric connection is ensured when the front side of the control circuit board is inserted into the female terminals of the first and second rows;
f) a second cable electrically coupled to the control circuit board, the rear end of the second cable being extended out of the insertion body and connected to the display;
g) a pair of elastic positioning pieces opposing to each other and arranged at both sides of the insertion body, the external side of the free end of the elastic positioning pieces being exposed to the left and right sides of the insertion body, each of the elastic positioning pieces having a locking member that is engaged into the engaging groove at both sides of the slot when the insertion body is inserted into the slot for establishing an electric connection;
h) a sensitive switch electrically connected to the control circuit board and having a touch control switch in connection to one of the elastic positioning pieces such that the control circuit board is switched on or off when the insertion body is inserted into or pulled out of the slot; and
i) an adjusting unit for automatically turning the image, the first and second signal contacts on the control circuit board serving as a detection module that determines if the female terminals of the first row or the female terminals of the second row is electrically coupled to the male terminals, wherein it is determined if the display is in an upright position or in an upside-down position, and wherein, when the display is in an upside-down position, an automatic image-turning process is performed.

2. The connection arrangement for an automotive display as recited in claim 1 wherein the positioning base is disposed at the bottom end of supporting stems of a headrest on the top of the seat back.

3. The connection arrangement for an automotive display as recited in claim 1 wherein the insertion body consists of a base member and a cover member, and wherein the rear end of the insertion body is formed as a hollow pivot joint such that the insertion body can be swiveled outward in a perpendicular position or swiveled back against the rear side of the display.

4. The connection arrangement for an automotive display as recited in claim 1 wherein each of the elastic positioning pieces internally includes an elastic piece.
